(19) United States
(12) Patent Application Publication
(10) Pub. No.: US 2016/0232936 A1
(43) Pub. Date: Aug. 11, 2016

(54) TRANSDUCER ARRAY TO WRITE DATA TO TAPE

(71) Applicant: Hewlett-Packard Development, L.P., Houston, TX (US)

(72) Inventors: Paul W Poorman, Boise, ID (US); Mike Alan Hoimberg, Boise, ID (US)

(21) Appl. No.: 14/903,592

(22) PCT Filed: Jul. 11, 2013
(86) PCT No.: PCT/US2013/050136

§ 371 Date: Jan. 7, 2016

(51) Int. Cl. G11B 15/18; G11B 5/008

(52) U.S. Cl. CPC G11B 15/1883; G11B 5/00813

(57) ABSTRACT

Tape heads are described herein including (i) a first module including a write transducer array with at least one transducer element to write data to a tape, and (ii) a second module including a write transducer array with at least one transducer element to write data to the tape. In examples herein, a lifting member with a curved portion formed at an inward edge of the module is provided to cause tape lifting the module and to prevent contact between the tape and the module at a trailing position with respect to tape travel direction.

### BACKGROUND

Current storage of computer data is implemented in a vast variety of applications. One technique for storing computer data is to record the data in a tape cartridge using a tape drive. For example, data may be recorded on and read from a moving magnetic tape with an electromagnetic read/write head (also referred to as tape head) positioned next to the magnetic tape. During operation of a tape drive, components of a tape head may suffer wear caused by tape contact. Wear of tape head components generally reduces reliability and operational life of a tape drive.

### BRIEF DESCRIPTION OF THE DRAWINGS

In order that the present disclosure may be well understood, various examples will now be described with reference to the following drawings.

FIG. 1 is a schematic representation of a tape drive according to an example.

FIGS. 2A and 2B are a schematic representation of bi-directional operation of an example of a tape head in the tape drive of FIG. 1.

FIG. 3 is a schematic isometric view of a tape head portion corresponding to the example of FIGS. 2A and 2B.

FIGS. 4A and 4B are a schematic representation of bi-directional operation of an example of a tape head in the tape drive of FIG. 1.

FIG. 5 is a schematic isometric view of a tape head portion corresponding to the example of FIGS. 4A and 4B.

FIG. 6 depicts a system for operating a tape drive according to an example.

FIG. 7 is a block diagram depicting a computer readable medium according to an example.

FIG. 8 is a flow diagram depicting a process to implement examples.

### DETAILED DESCRIPTION

In the following description, numerous details are set forth to provide an understanding of the examples disclosed herein, However, it will be understood that the examples may be practiced without these details. Further, in the following detailed description, reference is made to the accompanying figures, in which various examples are shown by way of illustration. In this regard, directional terminology, such as “top,” “bottom,” “front,” “back,” “left,” “right,” “vertical,”, “upper,” “lower,” etc., is used with reference to the orientation of the figures being described, Because disclosed components can be positioned in a number of different orientations, the directional terminology is used for purposes of illustration and is in no way limiting. Like numerals are used for like and corresponding parts of the various figures.

While a limited number of examples have been disclosed, it should be understood that there are numerous modifications and variations therefrom.

Elements of a tape head arrangement, in particular portions thereof including transducer elements, are generally exposed to wear through tape contact. This wear may be significant in view of tape abrasivity and the intimate contact that may be required between tape and head elements. Further, wear may be accentuated by the relatively high number of passes of the tape across the recording head, particularly in view of the trend to higher number of tracks in a given tape width. Wear may be a major cause of decrease in reliability and operating life of a tape head due to magnetic spacing loss.

Techniques are described herein that facilitate reducing wear of a tape head. According to some examples, a tape head is provided including a first module and a second module. Each of the first and second modules includes a write transducer array with at least one transducer element for writing data to the tape. According to some examples, each of the first and second modules may include a read transducer array disposed such that the tape head can perform bi-directional read-after-write by alternately operating these modules depending on the tape travel direction. According to other examples, a read module is provided between the first and second modules so that the tape head can perform bi-directional read-after-write by, (i) writing data by operating the write transducer elements in the module at leading position with respect to the tape travel direction, and (ii) reading the written data using the read module in both directions. It will be understood that other configurations are feasible for implementing read-after-write operation.

Lifting members may be provided so as to cause a lift of a tape portion over the module at the trailing position with respect to the tape travel direction. Such lifting members facilitate reducing the wear caused by tape contact on the write elements, which are generally delicate. In particular, lifting members as described herein facilitate distributing wear between the first and the second module. In some arrangements, wear on write elements during bi-directional operation of the tape head may be halved since tape contacts the write transducer only during tape travel in one of these directions. As further detailed below, lifting members may be implemented by suitably designing the contour of the first or second modules (including the write transducer arrays).

The above described lifting members may not interfere with tape head operation since contact with the write transducer array positioned at trailing module is not strictly required. That is, by including two write transducer arrays and at least one read transducer array, at most only two arrays would be in operation at any given time. Further, as illustrated in examples below, only a write transducer array at a leading module performs write during tape displacement in a particular direction. Transducers at a trailing module (over which the tape flies by the effect of the lifting members) may remain idle during tape travel in that direction.

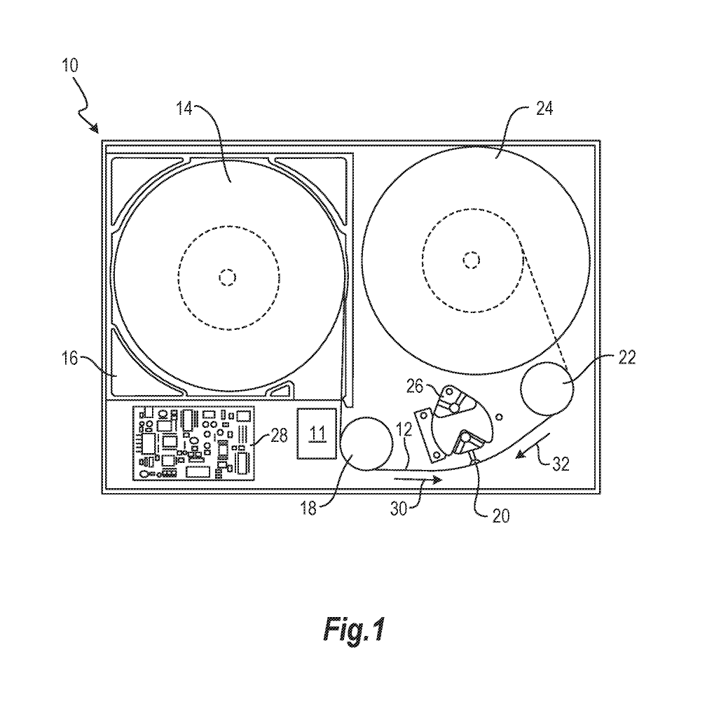

FIG. 1 is a schematic representation of a tape drive 10 according to an example. A magnetic tape 12 is initially wound on a supply reel 14 within a magnetic-tape cartridge 16. When loaded into tape drive 10, a tape drive mechanism 11 may cause opening cartridge 16, grasping a leader pin (not shown) mounted to a leader portion of tape 12, and threading tape 12 around a first guide roller 18, over a tape head 20, and around a second guide roller 22 to a take-up reel 24. Further, tape drive mechanism 11 is coupled to supply reel 14 and/or take-up reel 24 for causing tape 12 to travel along tape head 20 during operation of tape drive 10 for writing and/or reading.

Tape head 20 includes elements (e.g., two or more modules including arrays of transducer elements) to write data in and read data from tape 12. Tape head 20 may be particularly adapted for facilitating direct read-after-write operation of tape drive 10. Direct read-after-write is for verifying that a tape drive correctly writes data in a tape by reading written data quasi-simultaneously to writing.

Tape drive 10 may be bi-directionally operated. For example, tape drive 10 may have the capability to write data in and/or read data from tape 12 for alternate directions of tape travel. Such alternate directions may be (i) first travel direction 30 corresponding to travel of tape 12 from supply reel 14 to take-up reel 24, and (ii) second travel direction 32 corresponding to travel of tape 12 from take-up reel 24 to supply reel 14. Tape drive mechanism 11 may be responsible to cause tape 12 to travel either in first travel direction 30 or in second travel direction 32.

Tape head 20 may be moved in a vertical direction (i.e., normal to the plane of the drawing) by an actuator 26 in order to access different sets of tracks for reading and writing. Actuator 26 is, in turn, controlled by a tape-drive controller 28 that includes one or more processors, electronic memory, and logic circuitry. Functions performed by tape-drive controller 28 include, among others, receiving data from, e.g., an external host computer system, processing the data into data sets, writing the data sets to the magnetic tape by electromechanical control of tape head 20, reading data sets from magnetic tape 12 by electromechanical control of tape head 20, or processing the data sets to retrieve the host data that is returned to the host computer system.

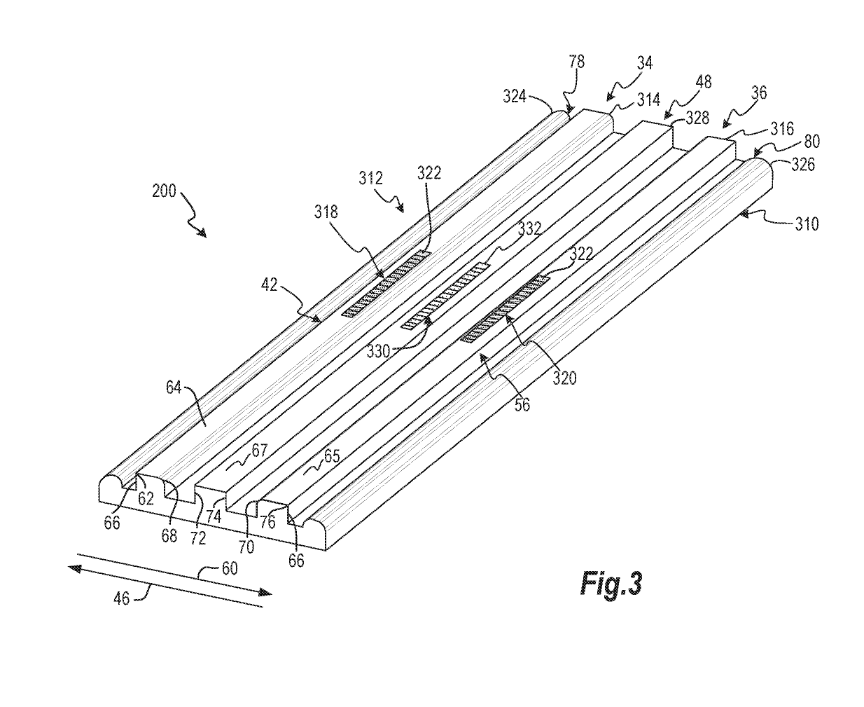

An example of a tape head that may be implemented in tape drive 10 is shown in greater detail in FIG. 3. A tape head arrangement 200 includes a head body 310 adapted to be mounted on a head support (not shown) by suitable mounts. Tape head arrangement 200 includes a tape side 312 configured to face tape 12 during operation of the tape head. Tape head arrangement 200 includes a first module 34 and a second module 36 at tape side 312. Both modules are formed as forwardly protruding and longitudinally extending rails 314, 316. “Forwardly” refers to the direction pointing towards tape 12 when tape head arrangement 200 is in operation.

Outriggers may be implemented in tape head arrangement 200 to facilitate stable dynamic behavior of tape 12 as tape 12 passes over tape side 312. Outriggers are structures disposed at outward portions of the tape head with respect to tape travel direction and arranged to direct a tape into a predetermined path along the tape head and/or precisely set the angle with which the tape overwraps adjacent module of the tape head. In the illustrated example, outriggers 78, 80 are implemented in the form of outer lateral rails 324, 326 extending longitudinally along head body 310.

Each of rails 314, 316 supports a respective write transducer array 318, 320. In the illustrated examples, each of write transducer arrays 318, 320 includes a plurality of write transducer elements 322 extending longitudinally along rails 314, 316. The write transducer elements may be implemented as magnetically sensitive thin-film magneto resistive elements. Rails 314, 316 physically interface with tape 12 as it is moved relative to tape head arrangement 200 so that write transducer array 318, 320 face a data carrying face of tape 12. Rails 314, 316 may further support servo transducer elements (not shown) that interface with servo tracks (not shown) at tape 12 to position the transducers of the tape head relative to data tracks arranged in parallel along tape 12.

In the illustrated example, tape head arrangement 200 further includes at tape side 312 a read module 48. Read module 48 is disposed between first module 34 and second module 36. Read module 48 is formed as a forwardly protruding and longitudinally extending rail 328. Rail 328 supports read transducer array 330. In the illustrated example, read transducer array 330 includes a plurality of transducer elements 332 to read data from tape 12. The read transducer elements 332 may be implemented as read elements including thin-film inductive elements. In the illustrated example, rail 328 of read module 48 includes skiving edges 72, 74 formed in outer portions of rail 328. Each of skiving edges 72, 74 is arranged to skive air from the interface between tape 12 and a tape bearing surface 67 of read module 48 when tape 12 approaches read module 48 towards that particular skiving edge. Read module 48 may further include servo transducer elements (not shown).

While FIG. 3, for purposes of illustration, shows only 18 sets of read/write transducer elements per array, in alternative embodiments arrays 318, 320, 330 may include any number of transducer elements, for example, sixteen read and/or write elements plus two servo elements per array for sixteen data track tape storage technology, or 32 read and/or write elements plus two servo elements per array for 32 data track tape storage technology. Generally, any convenient alternative number and/or suitable arrangement of arrays and transducer elements can be used.

In order to prevent wear, tape head arrangement 200 may include (i) a first lifting member 42 arranged to cause lifting of a tape portion over first module 34 while tape 12 moves in a first direction 46 such that tape 12 encounters, in the following order, second module 36 and first module 34, and (ii) a second lifting member 56 to cause lifting of a tape portion over second module 36 when tape 12 moves in a second direction 60 such that tape 12 encounters, in the following order, first module 34 and second module 36. More specifically, lifting members may be provided such that a lift is caused in the tape portion over the module at the trailing position so as to prevent or alleviate wear during operation of tape head arrangement 200.

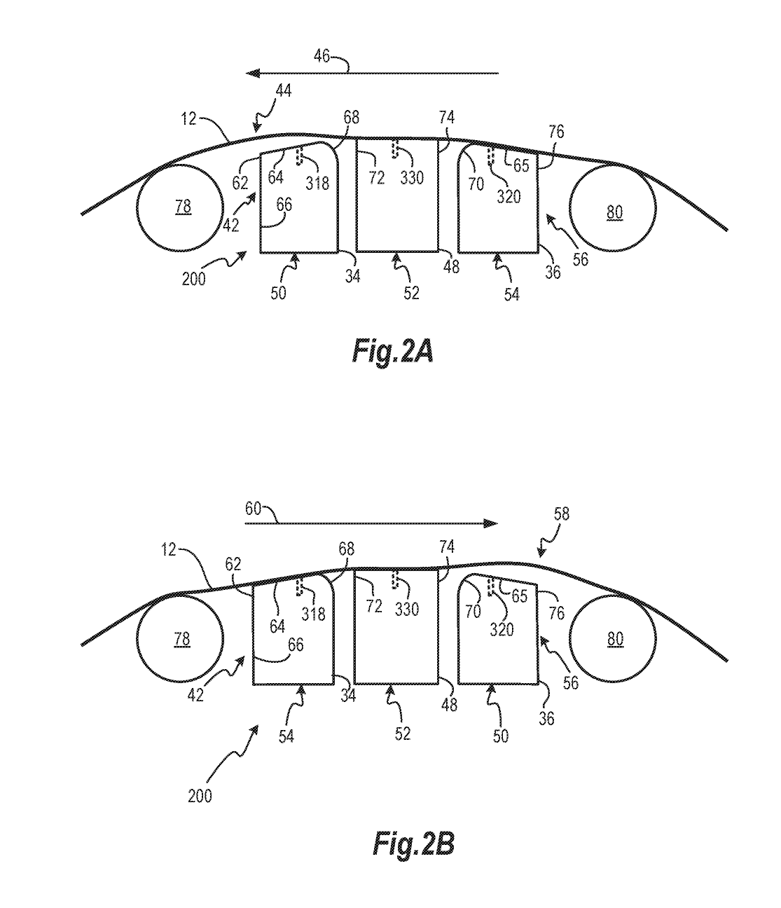

According to some examples herein, first lifting member 42 is integrally formed in first module 34 and/or second lifting member 56 is integrally formed in second module 36. FIGS. 2A, 2B, and 3 show a tape head arrangement according to one of these examples. Further, according to some examples herein, a lifting member is formed at the portion of a module that tape 12 first encounters when moving in the direction in which the lifting member causes tape lift. For example, in these Figures, lifting member 42 is shown implemented at an inward edge of first module 34 and lifting member 56 is implemented at an inward edge of second module 36. In particular, rails 314, 316 include curved portions 68, 70 built in inward portions of each rail so as to cause tape lift in a given direction.

A curved portion refers to a portion of a module having a surface with an oblique orientation relative to adjacent surfaces in the module. The curved portions illustrated herein cause a pressurization of air entering in the interface formed between the curved portion and the tape, thus creating a self-acting air bearing that causes tape lift over the portion of the transducer portion positioned downstream. A curved portion eliminates skiving on a tape portion approaching towards the curved portion. In the illustrated curved portions 68, 70 are curved portions of rails 314, 316 disposed, respectively, between flat bearing surfaces 64, 65 (supporting the write transducer arrays) and outward vertical surfaces 66 of rails 314, 316.

The curved portions 68, 70 as illustrated facilitate reducing tape contact on the module at a leading position with respect to the tape travel direction.

The curved portion 68 is shown in FIG. 3 as a curved portion for illustrative purposes. As used herein, a curved portion may be arranged with any profile suitable for facilitating entraining of air under a tape portion such that a tape lift as described herein is imparted. For example, a curved portion may be a portion with a curved profile, a beveled profile, a circular profile, blended profile, round profile, or a combination thereof. For example, curved portion 68 may have a radiused profile with a radius value between 2 and 8 mm, such as 3 mm. As used herein, a radiused profile refers to a profile with a shape according to a portion of a circle.

In the illustrated example, rails 314 and 316 include, respectively, skiving edges 62, 76 formed at outer portions of the rails. Skiving edges 62, 76 are arranged to skive air from the interface between tape 12 and a tape bearing surface 64, 65 of the module when tape 12 approaches a module towards its skiving edge.

FIGS. 2A and 2B illustrate, by way of example, operation of tape head arrangement 200 for bidirectional operation of tape drive 10. For performing read or write operations, tape 12 is brought close to or directly into contact with tape side 312 (see FIG. 3) of tape head arrangement 200 by following a pre-determined path with a pre-determined tension. Generally, the path and tension of tape 12 is determined by the relative spatial configuration of first guide roller 18, tape head arrangement 200, and second guide roller 22.

In order to implement, bi-directional read-after-write operation, a tape drive may operate modules 34, 36 to alternately perform writing depending on the particular tape direction, and read module 48 to perform reading. For example, tape drive 10 may be configured to perform the following process for a read-after-write operation in tape direction 46 using tape head arrangement 200: (i) move tap, 12 in direction 46 such that the tape encounters a) second module 36 at a leading position 54, b) read module 48 in a position 52 in-between first module 34 and second module 36, and first module 34 at a trailing position 50; (ii) write data to tape 12 using transducer array 320 of second module 36 and (iii) read the written data at (ii) from tape 12 immediately after performing (ii) using read transducer array 330 of read module 48. During this process, curved portion 68 causes a lift of tape portion 44 over first module 34 at trailing position 54. This lift does not interfere with the read-after-write operation since, in direction 46, write transducer array 318 of first module 34 remains idle while write transducer array 320 at second module 36 performs writing.

Further, tape drive 10 may be configured to perform the following process for a read-after-write operation in tape direction 60: (iv) move tape 12 in direction 60 such that the tape encounters a) first module 34 at a leading position 54, b) read module 48 in a position 52 in-between first module 34 and second module 36 at trailing position 50; (v) write data to tape 1 using transducer array 318 of first module 34; (vi) read the data written at (v) from tape 12 immediately after performing (v) using read transducer array 330 of read module 48. During this process, curved portion 70 causes a lift of tape portion 58 over second module 36 at trailing position 50. This lift does not interfere with the read-after-write operation since, in direction 60, write transducer array 320 at second module 36 remains idle while write transducer array 318 at first module 34 performs writing.

Bi-directional write-only operation may be analogously implemented by following the above processes omitting reading.

The process taking place during the above operation of tape head arrangement 200 is detailed in the following. As illustrated in FIG. 2A, when tape 12 is moved in direction 46, it encounters second module 36 at leading position 54, first at its skiving edge 76 and then at its curved portion 70. Skiving edge 76 causes tape 12 to come into intimate contact with write transducer array 320 of second module 36 so as to facilitate writing of data by the second module. Tape 12 then encounters skiving edge 74 of read module 48, disposed at position 52 in-between modules 34, 36. Skiving edge 74 causes tape 12 to come into intimate contact with read transducer array 330 of read module 48 so as to facilitate reading of data from tape 12. Tape 12 then encounters first module 34 and curved portion 68 of lifting member 42 which causes a lift of tape portion 44 over first module 34, which is at trailing position 50. Since in direction 46, tape 12 encounters second module 36 before read module 48, write transducer array 318 at first module 34 does not perform writing in this direction. Tape 12 flies over write transducer array 318 of first module 34

As illustrated in FIG. 2B, it will be understood that, when tape 12 is moved in direction 60, the roles of first module 34 and second module 36 are interchanged so that tape flies over second module 36 and write transducer array 318 at first module 34 performs writing in the read-after-write operation described above. In that direction, skiving edge 62 causes intimate contact of tape 12 with write transducer array 318, responsible for writing while tape 12 travels in direction 60.

An arrangement including two lifting members as illustrated herein significantly decreases wear of a module while the tape moves in a direction such that that module is at a trailing position. Actually, wear of a write transducer array may be halved as compared to an arrangement which does not implement lifting members as described herein, since tape 12 contacts the outward write transducers only during tape translation in one of the two directions in which the tape drive can be operated. That means that operating life of a tape drive may by doubled since, generally, wear of write transducer elements delimits operating life of the tape drive. In one example, for a given amount of pole tip recession due to wear, performance degradation of a read transducer element may be generally higher as compared to a write transducer element.

As set forth above, a tape head may include outriggers 78, 80 to direct a tape into a predetermined path along the tape head and/or precisely set the angle with which the tape overwraps adjacent modules of the tape head. An outrigger may be arranged as a separate structure of an adjacent module by providing a recess between the outrigger and an adjacent module, as illustrated in FIGS. 2A, 2B, 3. Alternatively, outriggers may be integrally formed in an adjacent module. In such integrated outriggers, an upper portion of the outrigger and the module are continuously formed without a recess therebetween.

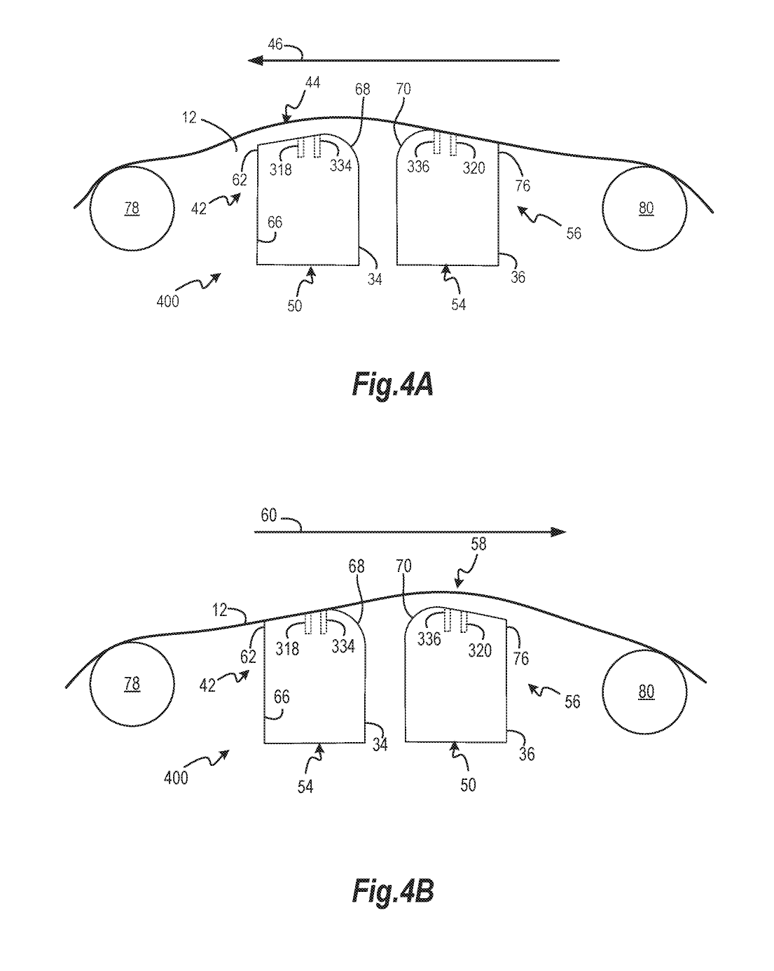

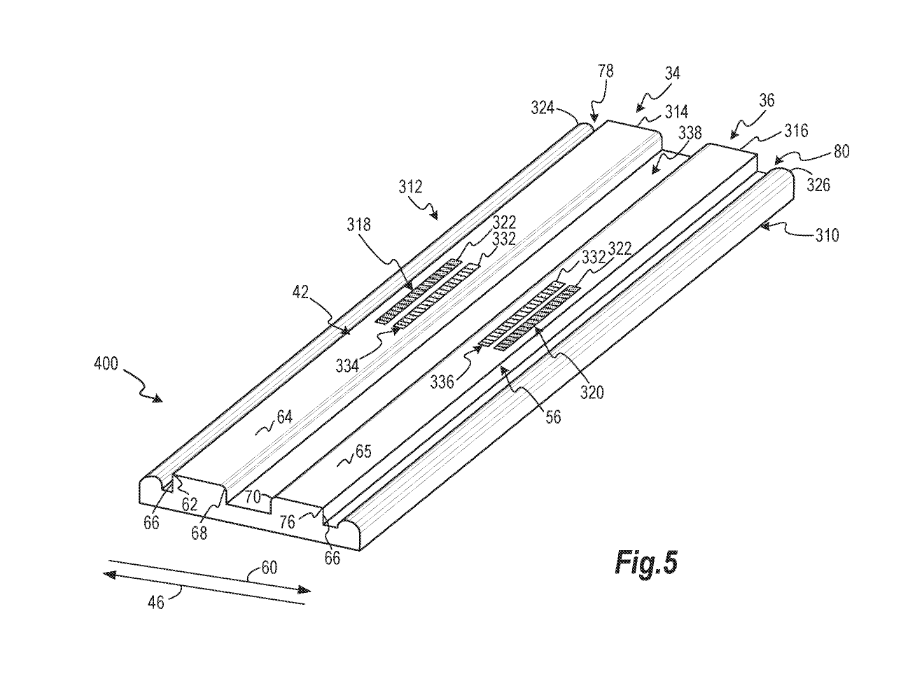

The examples illustrated above include a read module disposed in-between first and second modules arranged to perform reading. According to alternative examples, such read module may be mined by implementing read transducer arrays in the first and second modules. Such examples are illustrated with respect to FIGS. 4A to 5.

FIGS. 4A and 4B illustrate bi-directional operation of a tape head arrangement 400 in an analogous manner as described above with respect to the arrangement in FIGS. 2A and 2B. Referring to FIG. 5, it can be appreciated that read module 48 is omitted in this example. Instead thereof, for implementing reading, first module 34 includes a read transducer array 334 with read transducer elements 332. More specifically, rail 314 may support read transducer array 334. Read transducer array 334 and write transducer array 318 of first module 34 are aligned such that first module 34 can be operated to perform a read-after-write operation when tape 12 moves in direction 60. In this example, read transducer elements 332 of read transducer array 334 are disposed parallel to write transducer elements 322 of write transducer array 318. Further, write transducer array 318 antecedes read transducer array 334 when tape 12 moves in direction 60. Thereby, when tape 12 translates in direction 60, at first module 34 it first encounters write transducer array 318 and subsequently read transducer array 334.

Further, second module 36 includes a read transducer array 336 with read transducer elements 332. More specifically, rail 316 may support read transducer array 336. Further, read transducer array 336 and write transducer array 320 of second module 36 are aligned such that second module 36 can be operated to perform a read-after-write operation when tape 12 moves in direction 46. In this example, read transducer elements 332 of read transducer array 336 are disposed parallel to write transducer elements 322 of write transducer array 320. Further, write transducer array 320 antecedes read transducer array 336 when tape 12 moves in direction 46. Thereby, when tape 12 translates in direction 46, at second module 36 it first encounters write transducer array 320 and subsequently read transducer array 336. It will be understood that other relative arrangements of the read transducer arrays and write transducer arrays are possible that enable read-after-write operation using transducer elements at one module.

Analogously as for the arrangements illustrated above, tape head arrangement 400 includes lifting members 42 and 56 to cause lifting of tape 12 over the module at a trailing position. Since the module at leading position may perform read-after-write operation, lifting members 42 and 56 do not interfere in operation of tape head arrangement while alleviating wear at the module at trailing position.

The process involved in operating tape head arrangement 400 may be as follows. As illustrated in FIG. 4A, when tape 12 is moved in direction 46, it first encounters second module 36 at leading position 54, first at its skiving edge 76 and then at its curved portion 70. Skiving edge 76 causes tape 12 to come into intimate contact with write transducer array 320 and then read transducer array 336 of second module 36 so as to facilitate read-after-write operation. In direction 46, the transducer arrays at first module 34 remain idle (in this direction, the transducer arrays at second module 36 are operated). Tape 12 then encounters first module 34 and flies over read transducer array 318 and write transducer array 334 of first module 34.

As illustrated in FIG. 4B, it will be understood that, when tape 12 is moved in direction 60, the roles of first module 34 and second module 36 are interchanged so that tape portion 58 is lifted over second module 36 including read transducer array 336 and write transducer array 320; read transducer array 334 and write transducer array 318 at first module 34 are operated to perform the read-after-write operation described above. In that direction, skiving edge 62 causes intimate contact of tape 12 with write transducer array 318 and read transducer array 334, responsible for performing read-after-write in this direction. Examples providing write transducer arrays at the first and second module as described above facilitate reducing wear of the write transducer elements, since it is facilitated that the tape contacts the write transducer elements only during the tape travel direction in which the write transducer elements are operated. Tape contact with write elements of a module is prevented when that module is at trailing position.

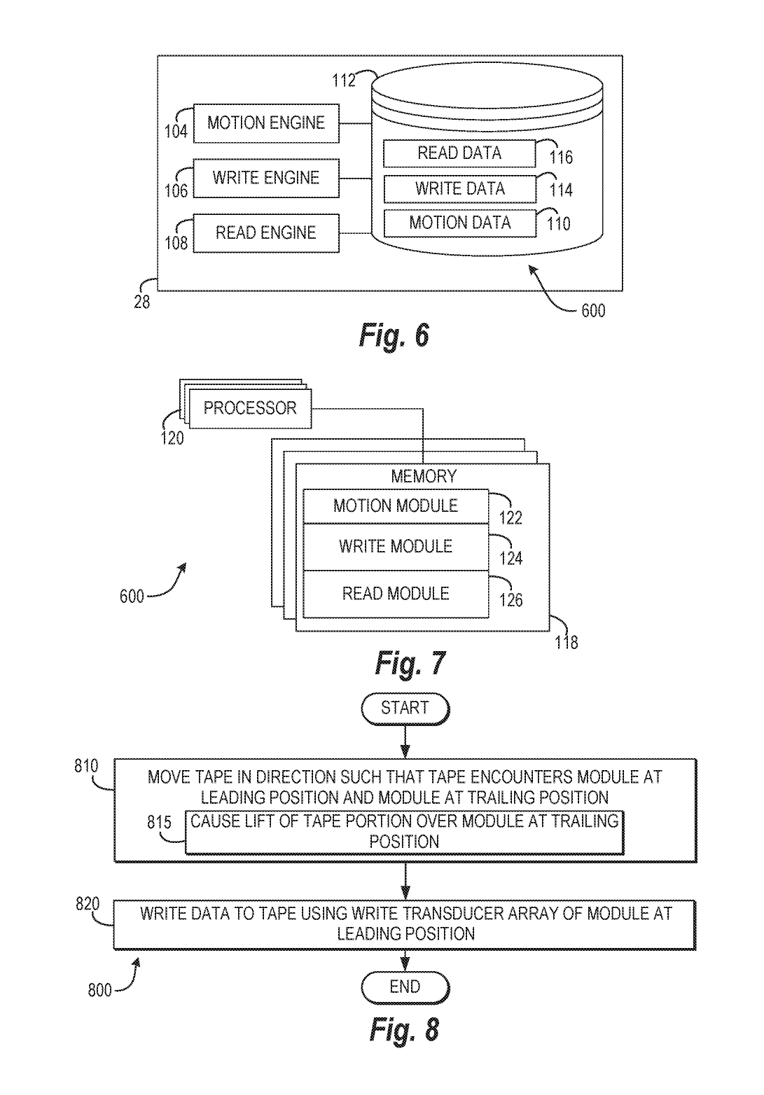

FIGS. 6 and 7 depict examples of physical and logical components for implementing operation of a tape drive. FIG. 6 depicts a system 600 for operating a tape drive. In the illustrated example, system 600 is illustrated as forming part of controller 28. It will be understood that system 600 may be provided separately from controller 28, either communicatively coupled thereto or to components of the tape drive system implementing the functions that system 600 controls. In the example, system 600 includes a motion engine 104, a write engine 106, and read engine 108.

Motion engine 104 represents generally any combination of hardware and programming configured to cause moving a tape as described herein. For example, referring to FIG. 1, motion engine 104 may be operatively connected to tape drive mechanism 11 for causing travel of tape 12 in first travel direction 30 or second travel direction 32. Motion engine 104 may cause tape movement in a direction such that the tape encounters a module at a leading position and a module at a trailing position as described above.

In some of the examples illustrated above (e.g., with respect to FIGS. 2A and 2B), motion engine 104 may cause tape 12 to encounter first module 34 at trailing position 50 when tape 12 moves in direction 46; motion engine 104 may cause tape 12 to encounter second module 36 at trailing position 50 when tape 12 moves in direction 60. As described above, first module 34 and second module 36 may be operated when being at leading position during a read-after-write operation depending on the tape travel direction. Motion engine 104 may cause tape travel according to motion data 110 stored in data store 112. Motion data 110 may store data regarding, among other parameters, tape travel direction or tape travel speed.

Motion engine 104 controls tape motion of tape to cause lift of a tape portion while moving the tape in a particular direction to prevent contact with the module at the trailing position. Such lift of a tape portion is induced by the travel of the tape close to a lifting member as illustrated above with respect to FIGS. 2 to 5. Generally, the speed of the tape is chosen such that a lifting member causes a tape lift appropriate to prevent tape contact with a module as described above.

Write engine 106 represents, generally, any combination of hardware and programming configured to writing data into a tape using a write transducer array at a module in a leading position as described above. For example, write engine 106 may cause write transducer array 320 at second module 36 to write data when tape 12 moves in direction 46 (see FIGS. 2A, 4A). Further, write engine 106 may cause write transducer array 318 at first module 34 to write data when tape 12 moves in direction 60 (see FIGS. 2B, 4B).

Read engine 108 represents generally any combination of hardware and programming configured to read written data from a tape using a read transducer array at a module as described above. For example, referring to FIGS. 2A and 2B, read engine 108 may cause read transducer array 330 at read module 48 to read data from tape 12 during tape travel in direction 46 or direction 60. Further, referring to FIGS. 4A and 4B, read engine 108 may cause (i) read transducer array 336 at second module 36 to read data when tape 12 travels in direction 46, and (ii) read transducer array 334 at first module 34 to read data when tape 12 travels in direction 60. Read engine 106 may cause storing data read from a tape as part of read data 116 in data store 112. In foregoing discussion, various components are described as combinations of hardware and programming, Such components may be implemented in a number of fashions.

Referring to FIG. 7 the programming may be processor executable instructions stored on a tangible memory medium 118 and the hardware may include a processor 120 for executing those instructions. Memory 118 can be said to store program instructions that when executed by processor 120 implements system 600 of FIG. 7. Memory 118 may be integrated in the same device as processor 120 (e.g., as part of controller 28) or it may be separate but accessible to that device and processor 120.

In one example, the program instructions can be part of an installation package that can be executed by processor 120 to implement system 600. In this case, memory 118 may be a portable medium such as a CD, DVD, or flash drive or a memory maintained by a server from which the installation package can be downloaded and installed. In another example, the program instructions may be part of an application or applications already installed. Here, memory 118 can include an integrated memory such as a hard drive.

In FIG. 7, the executable program instructions stored in memory 118 are depicted as a motion module 122, a write module 124, and a read module 126. Motion module 122 represents program instructions that, when executed, cause the implementation of motion engine 104 of FIG. 6. Likewise, write module 124 represents program instructions that when executed causes the implementation of write engine 106. Likewise, read module 126 represents program instructions that when executed causes the implementation of read engine 108.

FIG. 8 is an example of a flow diagram depicting a process to implement a method as described herein. In particular, process flow 800 represents an example of a method for operating a tape drive (e.g., tape drive 10). Process flow 800 may be implemented using a tape head arrangement with multiple modules that can be operated for writing as illustrated above. During tape travel in one particular direction, one of the modules for writing is at a leading position. Further, process flow 800 may be implemented using a tape head arrangement with a read module disposed in between two modules that respectively include write transducer arrays as illustrated with respect to FIGS. 2A and 2B. Alternatively, process flow 800 may be implemented using modules that include write transducer array and a read transducer array as illustrated with respect to FIGS. 4A and 4B.

At block 810, a tape is moved in a direction such that the tape encounters a module at a leading position and a module at a trailing position. Motion engine 104 may be responsible for implementing block 810 as described above. At block 820 data is written to the tape using the module at the leading position. Block 820 may further include reading data from the tape using a read module in the neighborhood of at least one of the modules. In a read-after-write operation, the data read at block 820 may be the data that has been previously written by the write transducer, the module at a leading position being used to perform writing and the read module in the neighborhood of at least one of the modules being used to perform reading. Alternatively, block 820 may include writing data into the tape using a write transducer array included in the module at the leading position; read-after-write operation is then implemented by operating the write and read transducers arrays of the module at the leading position. Write engine 106 and, optionally, read engine 108 may be responsible to implement block 820 as described above.

Block 810 includes a sub-block 815 of causing a lift of a tape portion by moving the tape over a lifting member. The lifted tape portion is over the module which is at the trailing position so as to prevent tape contact therewith. Motion engine 104 in conjunction with a lifting member as described herein (e.g., lifting member 42, lifting member 56) may be responsible to implement block 815 as described above. More specifically, motion engine 104 may cause tape travel along a lifting module such that an appropriate lift in imparted to a tape portion over a module downstream of the shifting module so as to prevent tape contact therewith. For example, block 815 may include moving the tape over a curved portion (e.g., curved portion 68 in FIG. 2A or curved portion 70 in FIG. 2B) of the module at the trailing position.

The examples described above facilitate alleviating wear of a tape head. As discussed above, the examples may be successfully deployed by implementing two lifting members. In each of the examples illustrated above, the lifting members in one tape head arrangement are of similar design. For example, in the arrangement of FIG. 3, each lifting member includes a curved portion to cause lifting of a tape portion over the adjacent module. However, it will be understood that lifting members of different designs may be included in the same tape head arrangement. For example, a lifting member may include a combination of elements described above collaborating so as to cause tape lift.

It will be appreciated that examples can be realized in the form of hardware, software module or a combination of hardware and the software module. Any such software module, which includes machine-readable instructions, may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of a non-transitory computer-readable storage medium that are suitable for storing a program or programs that, when executed, for example by a processor, implement embodiments. Accordingly, embodiments provide a program comprising code for implementing a system or method as claimed in any preceding claim and a non-transitory computer readable storage medium storing such a program.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations.

What is claimed is:

1. A tape head comprising:
a first module including a write transducer array with at least one transducer element to write data to a tape;
a second module including a write transducer array with at least one transducer element to write data to the tape;
a first lifting member having a first curved portion formed at an inward edge of the first module to cause lifting of a tape portion over the first module and to prevent contact between the tape and the first module while the tape moves in a first direction such that the tape encounters, in the following order, the second module and the first curved portion of the first module; and
a second lifting member having a second curved portion formed at an inward edge of the second module to cause lifting of a tape portion over the second module and to prevent contact between the tape and the second module when the tape moves in a second direction such that the tape encounters, in the following order, the first module and the second curved portion of the second module.

2. The tape head of claim 1 further comprising a read module including a read transducer array with at least one transducer element to read data from a tape, the read module being disposed between the first module and the second module such that, when the tape moves in the first direction, the tape encounters, in the following order, the second module, the read module and the first module.

3. The tape head of claim 1, wherein
the first module includes a read transducer array with at least one transducer element to read data, the write transducer array and the read transducer array of the first module being aligned such that the first module can be operated to perform a read-after-write operation when the tape moves in the second direction; and
the second module includes a read transducer array with at least one transducer element to read data, the write transducer array and the read transducer array of the second module being aligned such that the second module can be operated to perform a read-after-write operation when the tape moves in the first direction.

4. The tape head of claim 1, wherein the first lifting member is integrally formed in the first module and the second lifting member is integrally formed in the second module.

5. The tape head of claim 1, wherein:
the first lifting member is at the portion of the first transducer module that the tape first encounters when moving in the second direction; and
the second lifting member is at the portion of the second transducer module that the tape first encounters when moving in the first direction.

6. The tape head of claim 1, wherein:
the first curved portion is formed as part of the first module; and
the second curved portion is formed as part of the second module.

7. The tape head of claim 1, wherein at least one of the curved portion of the first module or the curved portion of the second module includes a portion with a curved profile, a beveled profile, a circular profile, blended profile, round profile, or a combination thereof.

8. The tape head of claim 1, further comprising:
a first outrigger disposed in the neighborhood of the first module; and
a second outrigger disposed in the neighborhood of the second module.

9. A tape drive, comprising:
a tape head including
(i) a first module including a write transducer array with at least one transducer element for writing data, and
(ii) a second module including a write transducer array with at least one transducer element for writing data;
a motorised drive for causing a tape to move in
(a) a first direction in which the first module is at a trailing position and the second module is at a leading position, and
(b) a second direction in which the first module is at a leading position and the second module is at a trailing position;
a first lifting member having a first curved portion formed on an inward edge of the first module arranged to cause a lift of a tape portion such that tape contact with the first module is prevented while the tape moves in the first direction;
a second lifting member having a second curved portion formed on an inward edge of the second module arranged to cause lift of a tape portion such that tape contact with the second module is prevented while the tape moves in the second direction; and
a circuit to cause
(i) the write transducer array of the first module to write data to the tape during a write operation in which the tape is moved in the second direction,
(ii) the write transducer array of the second module to write data to the tape during a write operation in which the tape is moved in the first direction.

10. The tape drive of claim 9 further comprising a read module including a read transducer array with at least one transducer element for reading data the read module being disposed between the first module and the second module, the circuit to cause
(i) the read transducer array of the read module to read data from the tape and the write transducer array of the first module to write data to the tape during a read-after-write operation in which the tape is moved in the second direction, and
(ii) the read transducer array of the read module to read data from the tape and the write transducer array of the second module to write data to the tape during a read-after-write operation in which the tape is moved in the first direction.

11. The tape drive of claim 9, wherein
the first curved portion is formed as part of the first lifting member;
the first curved portion is arranged to cause a tape lift preventing contact of the tape with the first module while the tape moves in the first direction;
the second curved portion is formed as part of the second lifting member;
the second curved portion is arranged to cause a tape lift preventing contact of the tape with the second module while the tape moves in the second direction.

12. A method for operating a tape drive, the method including:
moving a tape in a direction such that the tape encounters a module at a leading position and a module at a trailing position, each of the modules including a write transducer array with at least one transducer element for writing data to the tape; and
writing data to the tape using the write transducer array of the module at the leading position with respect to a direction of tape travel; wherein
moving the tape includes moving the tape over a lifting member with a curved portion formed on an inward edge of the module so as to cause a lift of a tape portion over the module at the trailing position while moving the tape in said direction.

13. The method of claim 12, further comprising reading data includes reading data using a read transducer array of a read module disposed in-between said modules.

14. The method of claim 12, wherein moving the tape includes moving the tape over the curved portion of the module at the trailing position so as to cause the lift of the tape portion.

15. The method of claim 12, wherein the curved portion of the module includes a portion with a curved profile, a beveled profile, a circular profile, blended profile, round profile, or a combination thereof.
